(19) United States
(12) Patent Application Publication
(10) Pub. No.: US 2004/0191375 A1
(43) Pub. Date: Sep. 30, 2004

(54) Process for the preservation of coconut sap (neera)

(76) Inventors: Kulathooran Ramalakshmi, Karnataka (IN); Mysore Nagarajarao Ramesh, Karnataka (IN); Bashyam Raghavan, Karnataka (IN); Vishweshwaraiah Prakash, Karnataka (IN)

Correspondence Address: Law Office - Dinesh Agarwal, P.C., Suite 330, 5350 Shawnee Road, Alexandria, VA, 22312, US

(21) Appl. No.: 10/396,710

(22) Filed: Mar. 26, 2003

(51) Int. Cl. A23K 1/00

(52) U.S. Cl. 426/325

(57) ABSTRACT

This present invention relates to a process for preserving coconut sap (neera) by collecting the sap, acidifying and storing in containers thereby retaining its natural constituents.

### FIELD OF THE INVENTION

This invention relates to a process for the preservation of coconut sap (neera). The process, in particular, describes the method of preservation of coconut sap in glass bottles.

### BACKGROUND OF THE INVENTION

Coconut palm botanically known as Cocos nucifera L. belongs to the natural order Arecaceae (Palmoe) an important member of monocotyledons. A sugar containing juice or sap is obtained by tapping the unopened spadix of the coconut palm. The tapping involves the extraction of exuded sap from the inflorescence that yields sweet sap. The tapping methods vary from country to country and within the country. In India and Sri Lanka, the spadix is considered ready for tapping when the mature one is burst or just about to do so. The female flowers within the unopened spathe cause a swelling at the base and its appearance is an indication of the appropriate stage for tapping.

The tapping is usually continued for a period of six months and there may be 3 or more spathes on the same tree being tapped at the same time. The maximum yield of coconut sap is usually obtained in the third month after the commencement of tapping. The yield of coconut sap is highly variable. It varies considerably from day to day, season to season, spadix to spadix and tree to tree. The average yield of coconut sap is about 1.5 litres per palm per day.

The fresh coconut sap is rich in carbohydrates with sucrose as its main constituent. It is well known that the coconut sap ferments very quickly thus producing alcohol in it. The fermented sap smells obnoxiously thus making it unacceptable as a beverage for consumption. Hence, there is a need to preserve the coconut sap without affecting its nutritional quality.

Patent search revealed that there is no patent available on the processing and preservation of coconut sap. However, there are two research articles published on different aspects of coconut sap.

Reference may be made to an article on microbiology and biochemistry of natural fermentation of coconut sap [Atputharajah et al, 1986 , Food Microbiology, 3 (4), 273-280] wherein various microbiological, physical and chemical changes occurring during the entire period of natural fermentation have been studied. However, no solution was provided for arresting the fermentation and preserving the coconut sap.

Reference may also be made to an article [Samarajeewa et al, 1985, Food Microbiology, 2 (1), 11-17] wherein the sap was sterilized with 0-200 ppm of sodium metabisulphite and cultures of various organisms were inoculated into treated sap. The cultures used were: a mixed inoculum of non-ethanol producers (Lactobacillus, Leuconostoc, Staphylococcus, Bacillus circlans and Enterobacter), or pure cultures of Saccharomyces cerevisiae, 2 strains of Sacc. Chevalieri, Schizosaccharomyces pombe, and commercial champagne, hock and sauterne yeasts. The objective of this study was to suppress non-ethanol producers and to enhance ethanol formation by natural flora. This is contrary to our interest of arresting ethanol production.

Applicants co-pending PCT application No. PCT/IB02/05389 filed on Dec. 16, 2002 describes a process for the preservation of deodourised coconut sap, which comprises: collecting coconut sap from the spathe of coconut palm, which is tapped earlier for more than 10 days using a pot, filtering the sap of step (a) to remove any impurities; chilling the filtered sap to 2-8° C. until processing, adding deodourizing aids and stirring the contents; centrifuging or filtering the mixture; optionally adding a preservative, packing the deodourised sap in glass containers and crowning the glass bottles, and pasteurizing the bottles at 90-95° C. for 3-7 min. The present application is different from the co-pending application that the present application discloses a new process for the preservation of coconut sap, which retains its natural constituents.

### OBJECTS OF THE INVENTION

The main object of the present invention is to provide a process for the preservation of fresh coconut sap.

Another object of the present invention is to provide a process for the preservation of coconut sap by retaining its cloudiness.

### SUMMARY OF THE INVENTION

The present invention provides an improved process for the preparation coconut sap collected from the spathe of coconut palm by retaining all its cloudiness and natural constituents.

### DETAILED DESCRIPTION OF THE INVENTION

Accordingly, the present invention provides a process for the preservation of coconut sap, the said process comprising steps of:

a) collecting coconut sap from the spathe of coconut palm, which is tapped earlier for more than 10 days using a mud pot,

b) filtering the sap of step (a),

c) chilling the filtered sap solution of step (b),

d) adding an acidulant to the step (c) solution,

e) adding preservative to step (d) solution,

f) bottling the step (e) solution and croning the glass bottles, and

g) pasteurizing the bottles of step (f) for a time period of 3 to 7 minutes

The process for the preservation of coconut sap is illustrated in the following flow chart:

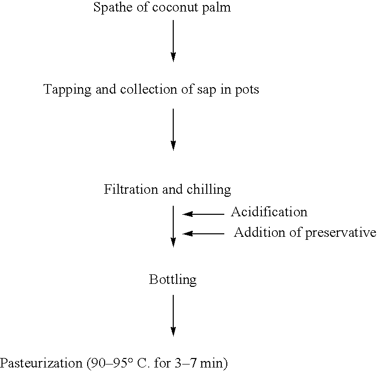

In an embodiment of the present process, the temperature for chilling is in the range of 2° to 8° C.

In another embodiment of the present process, the acidulant used is citric acid.

In still another embodiment of the present process the concentration of acidulant used is in the range of 0.04 to 0.2%.

In yet another embodiment of the present process, the preservative used is nisin.

In another embodiment of the present process, the concentration of nisin used is in the range of 5 to 15 ppm.

In yet another embodiment of the present process, the coconut sap retains its natural constituents.

In an embodiment of the present invention, the collection of the coconut sap is best carried out from 18.00 hours to 06.00 hours next day, during which period of fermentation of the sap is kept to a minimum.

In another embodiment of the present invention, an acidulant (citric acid) and a preservative (nisin) are added for commercial sterility during the storage period.

The novelty of the process lies in development of a process for the preservation of coconut sap retaining its natural constituents.

The applicability of the process is further illustrated in the following examples. However, this should not be construed to limit the present invention.

### EXAMPLE 1

Coconut sap (20 L) was collected in the early morning from the nearby coconut farm, with healthy trees, identified specifically for the purpose, transported to the laboratory in the mobile chiller (4° C.) (designed by CFTRI). The soluble solids content and pH of the coconut sap was 16° brix and 4.7 respectively. The sap was mixed with citric acid (0.09%) and nisin (10 ppm), filled in glass bottles (200 ml) with a headspace of about 10 ml, crowned and pasteurized at 90° C. for 7 minutes. The bottles were cooled to 27° C. The sap had a characteristic cloudy appearance of ‘neera’, devoid of fermented odour without any sedimentation.

### EXAMPLE 2

Coconut sap (10 L) was collected from the coconut farm in the early morning, transported to the laboratory in the mobile chiller (4° C.) (designed by CFTRI). The sap was analysed for pH and solids content (4.3 and 15° brix). The sap was mixed with citric acid (0.045%) and nisin (10 ppm), filled in glass bottles (200 ml) with a headspace of about 10 ml, crowned and pasteurized at 95° C. for 5 minutes. The bottles were cooled to ambient temperature (27° C.). The sap had a characteristic cloudy appearance of ‘neera’, devoid of the fermented odour without any sedimentation.

### EXAMPLE 3

Coconut sap (30 L) was collected from the coconut farm in the early morning, transported to the laboratory in the mobile chiller (4° C.) (designed by CFTRI). The soluble solids content and pH of the coconut sap was 15° brix and 4.76 respectively. The sap was mixed with citric acid (0.09%) and nisin (10 ppm), filled in glass bottles (200 ml) with a headspace of about 10 ml, crowned and pasteurized at 95° C. for 5 minutes. The bottles were cooled to 27° C. The sap had a characteristic cloudy appearance of ‘neera’, devoid of fermented odour without any sedimentation.

While this invention has been described as having preferred sequences, ranges, steps, materials, or designs, it is understood that it includes further modifications, variations, uses and/or adaptations thereof following in general the principle of the invention, and including such departures from the present disclosure as those come within the known or customary practice in the art to which the invention pertains, and as may be applied to the central features hereinbeforesetforth, and fall within the scope of the invention and of the limits of the appended claims.

We claim:

1. A process for the preservation of coconut sap, the said process comprising steps of:
a) collecting coconut sap from the spathe of coconut palm, which is tapped earlier for more than 10 days using a mud pot,
b) filtering the sap of step (a),
c) chilling the filtered sap solution of step (b),
d) adding an acidulant to the step (c) solution,
e) adding preservative to step (d) solution,
f) bottling the step (e) solution and croning the glass bottles, and
g) pasteurizing the bottles of step (f) for a time period of 3 to 7 minutes.

2. A process of claim 1, wherein in step (c) the temperature for chilling is in the range of 2° to 8° C.

3. A process of claim 1, wherein in step (d) the acidulant used, is citric acid.

4. A process of claim 3, wherein the concentration of acidulant is in the range of 0.04 to 0.2%.

5. A process of claim 1, wherein in step (e) the preservative used, is nisin.

6. A process of claim 5, wherein the concentration of nisin used is in the range of 5 to 15 ppm.

7. A process of claim 1, wherein the coconut sap retain its natural constituents.
